(19) United States
(12) Patent Application Publication
(10) Pub. No.: US 2025/0386967 A1
(43) Pub. Date: Dec. 25, 2025

(54) SYSTEM AND METHOD FOR DETECTING A FLUID LEVEL

(71) Applicant: BREVILLE PTY LIMITED, Alexandria (AU)

(72) Inventors: Duncan Bruce HELLMERS, Alexandria (AU); Johnson THIE, Alexandria (AU); Stephen John MCCLEAN, Alexandria (AU)

(21) Appl. No.: 18/878,610

(22) PCT Filed: Jun. 29, 2023
(86) PCT No.: PCT/AU2023/050598

§ 371 Date: Dec. 23, 2024

(30) Foreign Application Priority Data
Jun. 30, 2022 (AU) 2022901830

(51) Int. Cl. A47J 31/44; A47J 31/52; G01F 23/72

(52) U.S. Cl. CPC A47J 31/4457; A47J 31/52; G01F 23/72; A47J 2203/00

(57) ABSTRACT

A fluid level detection system to determine a level of a fluid in a container engageable with a kitchen device, the fluid level detection system comprising a float comprising a magnet, the float being located in the container and movable relative to the container, a sensor configured to detect a magnetic flux associated with the magnet, the sensor being located in the kitchen device, and a controller communicatively coupled to the sensor, the sensor configured to provide to the controller a real-time feedback of the detected magnetic flux as the float moves relative to the container, wherein the controller is configured to determine the level of the fluid in the container based on the detected magnetic flux.

### FIELD

The present invention relates to a system and method for detecting a fluid level. In particular, the invention relates to fluid level detection systems installed in kitchen devices, and use thereof, for detecting a fluid level in a container associated with the kitchen device.

### BACKGROUND

Detecting the quantity of water in the water tank of kitchen devices such as coffee machines, steam ovens etc. often involves simple switches that provide a simple on/off signal to indicate when the tank is empty or full. Such switches are unable to provide an indication of a current level of water in the tank or the volume of water in the tank. Moreover, such switches are unable to detect if the water tank is located in its correct position for use and has been engaged with the kitchen device.

### SUMMARY

It is an object of the present invention to substantially overcome, or at least ameliorate, one or more of the disadvantages of existing arrangements, or at least provide a useful alternative to existing arrangements.

In a first aspect, although not necessarily the only or broadest form, the invention resides in a fluid level detection system to determine a level of a fluid in a container engageable with a kitchen device, the fluid level detection system comprising:
a float comprising a magnet, the float being located in the container and movable relative to the container;
a sensor configured to detect a magnetic flux associated with the magnet, the sensor being located in the kitchen device; and
a controller communicatively coupled to the sensor, the sensor configured to provide to the controller a real-time feedback of the detected magnetic flux as the float moves relative to the container,
wherein the controller is configured to determine the level of the fluid in the container based on the detected magnetic flux.

Preferably, the controller is configured to determine that the container is not engaged with the kitchen device when the detected magnetic flux is lower than a predetermined value.

Preferably, the real-time feedback of the detected magnetic flux comprises a series of values of the detected magnetic flux, each value in the series of values of the detected magnetic flux being associated with a position of the float relative to the container that is different from positions of the float associated with remaining values in the series of values of the detected magnetic flux.

Preferably, the kitchen device is a coffee machine. Preferably, the container is a water tank. Preferably, the fluid is water.

Preferably, the float moves along a channel. Preferably, the channel is formed by a pair of guides. Preferably, the guides have a L-shaped cross-sectional shape. Preferably, the guides extend substantially along the height of a side wall of the container. Preferably, the float moves from a lower end of the container to an upper end of the container.

Preferably, the magnet is embedded in the float. Preferably, average density of the float is lower than the density of water.

Preferably, the sensor is a magnetometer. Preferably, the sensor is located adjacent a bottom wall of the container. Preferably, the detected magnetic flux is a magnitude of the magnetic flux associated with the magnet. Preferably, the magnetometer is configured to detect magnetic flux along a predetermined axis.

Preferably, each position of the float relative to the container is associated with a unique magnetic flux value.

Preferably, the controller is configured to determine a rate of change of the level of the fluid based on a rate of change of the detected magnetic flux. Preferably, the controller is configured to determine a volume of the fluid in the container. Preferably, the controller is configured to alert a user when the level of the fluid is low.

In a second aspect, the invention resides in a method of detecting a fluid level of a fluid in a container engageable with a kitchen device, the method comprising:
detecting, by a sensor located in the kitchen device, a magnetic flux associated with a magnet in a float, the float being located in the container and movable relative to the container;
determining, by a controller communicatively coupled to the sensor, the level of the fluid in the container based on the detected magnetic flux,
wherein the sensor provides to the controller a real-time feedback of the detected magnetic flux as the float moves relative to the container.

Preferably, determining the level of the fluid in the container includes:
determining, by the controller, a rate of change of the level of the fluid based on a rate of change of the detected magnetic flux.

Preferably, the method further comprises:
selectively disabling an option on a display of the kitchen device based on the level of the fluid, and
receiving a user input to prepare a beverage, wherein the level of the fluid corresponds to a volume of the fluid that is sufficient to prepare the beverage.

Preferably, the method further comprises:
determining, by the controller, a time period since the level of the fluid was at a minimum level; and
based on the determined time period, alerting a user to refill the container.

Preferably, the sensor provides the real-time feedback of the detected magnetic flux as the float moves from a lower end of the container to an upper end of the container.

### BRIEF DESCRIPTION OF THE DRAWINGS

For a more complete understanding of the present invention, exemplary embodiments of the invention are explained in more detail in the following description with reference to the accompanying drawing figures, in which like reference signs designate like parts and in which:

FIG. 1 is a perspective view of a kitchen device including a fluid level detection system, according to an embodiment of the invention.

FIG. 2 is an exploded perspective view of the kitchen device shown in FIG. 1.

FIG. 3 is a front view of the kitchen device shown in FIG. 1 with a low fluid level.

FIG. 4 is a front view of the kitchen device shown in FIG. 1 with a high fluid level.

### DETAILED DESCRIPTION

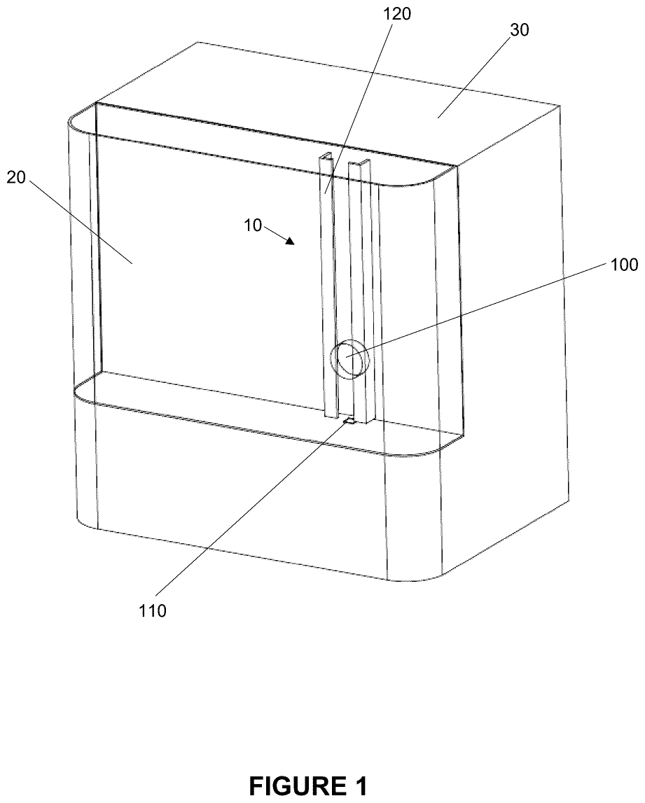

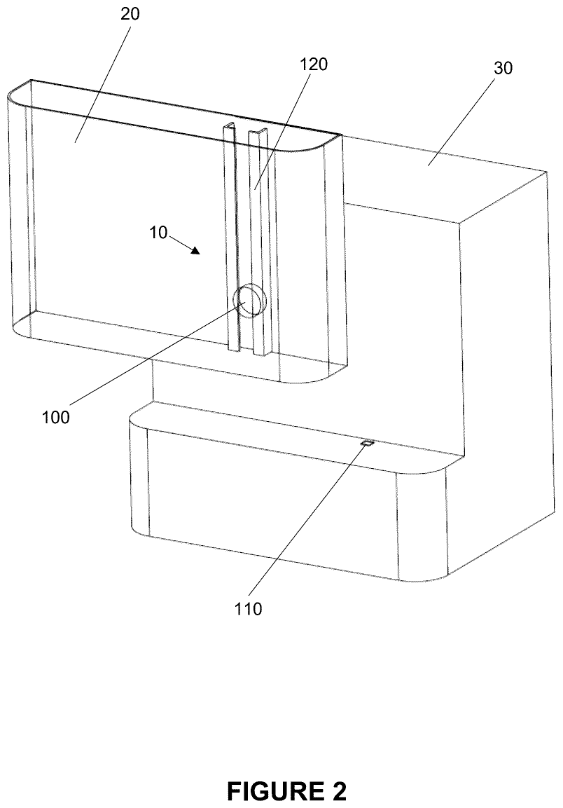

FIGS. 1-4 illustrate a fluid level detection system 10 located in a container 20 and a kitchen device 30, the fluid level detection system 10 being configured to determine a level of a fluid in the container 20. The container 20 is associated and/or engageable with the kitchen device 30. In this embodiment, the container 20 is a water tank and the kitchen device 30 is a coffee machine. However, in further embodiments, the container 20 may be filled with other fluids, for example, milk, flavoured syrups etc. and/or the kitchen device 30 may be a different type of kitchen device such as water dispenser, steam oven, refrigerator, kettle etc.

The fluid level detection system 10 comprises a float 100 located in the container 20 and movable relative to the container 20, a sensor 110 located in the kitchen device 30 and a controller (not shown) communicatively coupled to the sensor 110. The float 100 comprises a magnet (not shown) and is freely movable relative to the container 20 along a channel formed by a pair of guides 120 attached to a wall of the container 20, the guides 120 having a L-shaped cross-sectional shape. The magnet is embedded or enclosed in the float 100, with the average density of the resulting float 100 being lower than the density of water to allow the float 100 to float at the water level. However, in further embodiments, the float 100 may be retained in the container 20 by other means that still allows it to move relative to the container 20, for example, a flexible connecting member, channel comprising one or three or more guides etc. and/or the guides may be differently shaped, for example, curved, U-shaped, irregularly shaped etc.

The guides 120 extend substantially along the entire height of a side wall of the container 20, thereby allowing the float 100 to move from a lower end of the container 20 to an upper end of the container 20 to detect the water level.

The sensor 110, in the form of a magnetometer, is located in the kitchen device 30 adjacent a bottom wall of the container 20 and measures the magnetic flux associated with the magnet in the float 100. The sensor 110 is configured to detect the magnetic flux along a predetermined axis (i.e. the ‘z’ axis). In particular, the sensor 110 is located in a portion of the kitchen device 30 that is adjacent and directly under the guides 120 when the container 20 is engaged with the kitchen device 30. The controller is also located in the kitchen device 30 and communicatively coupled to the sensor 110 such that data from the sensor 110 may be received and processed by the controller. However, in further embodiments, the sensor 110 may be a different type of sensor that can detect magnetic flux, for example, gaussmeter, teslameter, fluxmeter etc.

As the sensor 110 measures the magnitude of the magnetic flux associated with the float 100, the sensor 110 is able to detect a change in the magnetic flux when the float 100 moves relative to the container 20 due to a change in the fluid level. When the fluid level in the container 20 rises (due to refilling water), the float 100 rises and moves upwards with the fluid level, thereby increasing a distance between the float 100 and the sensor 110. This increase in distance between the float 100 and the sensor 110 results in a decrease in magnetic flux detected by the sensor 110, thereby providing an indication of the water level. Similarly, when the fluid level in the container 20 falls (due to consumption of water by the kitchen device 30), the float 100 moves downwards with the fluid level, thereby decreasing a distance between the float 100 and the sensor 110 which results in an increase in magnetic flux detected by the sensor 110. As each position of the float 100 along the channel is associated with a particular and distinct value of magnetic flux detected by the sensor 110, the controller is able to determine the fluid level in the container 20 based on the value of the detected magnetic flux. The controller is also able to determine a rate of change in the fluid level based on the rate of change in the magnetic flux.

The container 20 (water tank) engages with the kitchen device 30 (coffee machine) so that water from the water tank may be used to brew coffee in the coffee machine. The container 20 has an opening through which fluid may be poured in and the container 20 can be disengaged and separated from the kitchen device 30 for washing or refilling.

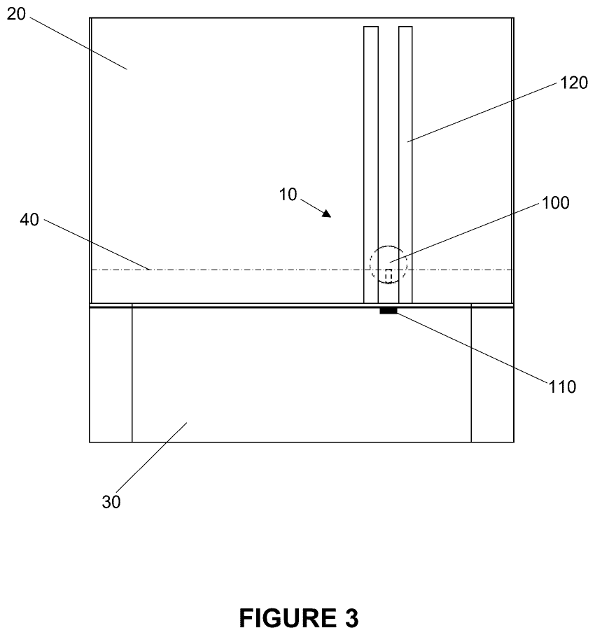

In use, when the fluid level 40 in the container 20 is low (as shown in FIG. 3), the float 100 is located adjacent the lower end of the container 20 and close to the sensor 110. At this position of the float 100, the magnetic flux detected by the sensor 110 is relatively high and the value of the detected magnetic flux is transmitted to the controller. Next, as the container 20 is being refilled, the float 100 starts to move upwards with the rising water level and the value of the magnetic flux detected by the sensor 110 starts to decrease. The sensor 110 provides a real-time feedback of the detected magnetic flux to the controller as the float 100 moves relative to the container 20. The real-time feedback of the detected magnetic flux comprises a series of values of the detected magnetic flux, where each value in the series of values of the detected magnetic flux is associated with a position of the float 100 relative to the container 20 that is different from positions of the float associated with remaining values in the series of values of the detected magnetic flux, i.e. each position of the float 100 relative to container 20 has a unique magnetic flux value associated with it. Thus, the controller is able to determine the fluid level 40 at any time when the container 20 is engaged with the kitchen device 30, irrespective of whether the container 20 is empty, full or partially filled. Moreover, the rate of increase or decrease in the values of the series of values of the detected magnetic flux provides an indication of the rate of change of fluid level, i.e. the rate at which the container 20 is being refilled or the rate at which the water from the container 20 is being consumed by the kitchen device 30.

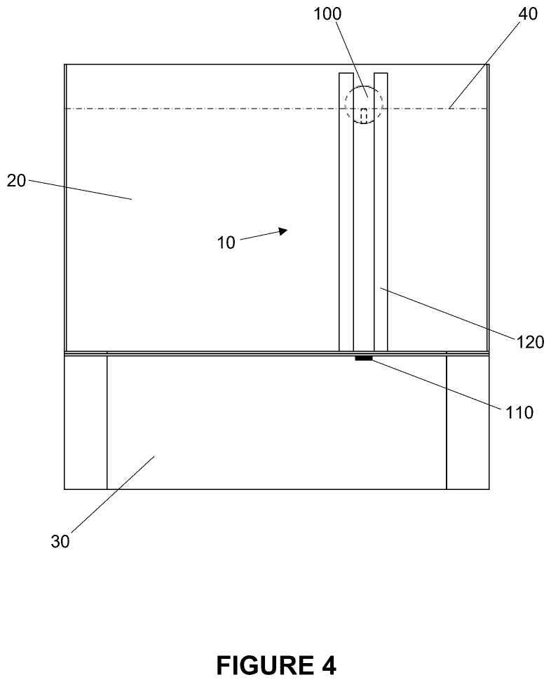

When the container 20 has been refilled and the fluid level 40 in the container 20 is high (as shown in FIG. 4), the float 100 is located adjacent the upper end of the container 20 and at a distance from the sensor 110. At this position of the float 100, the magnetic flux detected by the sensor 110 is relatively low, and the controller determines the fluid level 40 accordingly.

As the shape and volume of the container 20 is known, the fluid level 40 determined by the controller may be used to determine a volume of the fluid in the container 40. Further, when the container 20 is disengaged from the kitchen device 30 and located at a distance from the kitchen device 30, the value of the magnetic flux detected by the sensor 110 would be zero or extremely low (depending on the location of the container 20 relative to the kitchen device 30). Thus, when the detected magnetic flux is below a predetermined value, the controller can determine that the container 20 is not engaged with the kitchen device 30. The controller can then alert the user, via a display of the kitchen device 30, to engage the container 20 with the kitchen device 30.

The data determined by the controller can be used for various functions and/or displayed to the user via a display (for example, a LED or TFT screen) on the kitchen device 30 or a mobile device. For example, displaying the fluid level on a display eliminates the need for a user to lean over and visually monitor the fluid level 40 in the container 20 to avoid overflow. Various prompts or information associated with the determined fluid level such as “Refill”, “Full”, the volume of water in the container 20, the percentage of the container 20 that is filled etc. can also be displayed on the display of the kitchen device 30 or on a mobile device. Further, when the fluid level 40 in the container 20 is too low (or below a predetermined minimum level) to perform a specific function such as brewing coffee, running a descale cycle etc., the controller of the kitchen device 30 can alert the user by displaying a message on the display or by illuminating specific lights/indicators on the kitchen device 30.

The data determined by the controller can also be used to modify options available to the user, alter recipes of beverages to be dispensed, predict user behaviour and assist with the descaling process, as discussed below.

The fluid level 40 determined by the controller can be used to issue user alerts or modify options displayed on the display of the kitchen device 30 or a mobile device. For example, if the detected fluid level is associated with a quantity/volume of water that is insufficient to prepare a beverage selected by the user, the kitchen device 30 would issue an alert to the user that there is insufficient water in the container 20 to prepare the beverage, or particular options on the display of the kitchen device 30 or mobile device can be selectively disabled, thereby preventing the user from selecting beverages or quantity thereof for which there is insufficient water in the container 20. The detected fluid level 40 can also be used to provide an estimate of the quantity of coffee that can be brewed from the water in the container 20. Alternatively, when there is insufficient water in the container 20 to prepare a beverage selected by the user, the kitchen device 20 may alter the recipe of the beverage based on the detected fluid level to ensure that the dispensed beverage is satisfactory. As a further alternative, the user may also be provided with an option to modify the recipe based on the detected fluid level and the volume of water in the container 20, and the user may be provided with recommendations on how to modify the recipe based on the volume of water in the container 20, along with a potential effect of implementing the recommended modification to the recipe. Should the user choose to refill the container 20 when the kitchen device 30 alerts the user that there is insufficient water in the container 20, the controller would be able to determine the change in fluid level and the increase in quantity of water in the container 20, resulting in the previously disabled options on the display being enabled again. The user may then select a different beverage option from the display (by providing a user input), such that the fluid level corresponds to a volume of water that is sufficient to prepare the selected beverage.

In further embodiments where the kitchen device 30 is a steam oven, the user may be prompted by the steam oven to specify a duration for which steam should produced during the cooking process based on a detected fluid level and corresponding volume of water available to produce steam.

The fluid level determined the controller also assists in ensuring that the descaling process is being performed properly. In particular, the volume of water being utilized over a period of time may be determined based on the magnetic flux detected by the sensor 110. If the user has not inserted a silicone disc in the portafilter of the coffee machine/kitchen device 30 during the descaling process, the water being utilized would pass through the portafilter and flow out. This could be detected by the controller based on the magnetic flux detected by the sensor 110 and an alert can be issued to the user to insert the silicone disc in the portafilter.

The fluid level determined the controller may be recorded to determine the time period for which a particular quantity of water has been present in the container or the time period since the fluid level was at a minimum level (i.e. the container 20 was empty). Users may not completely empty the container 20 prior to refilling, and instead add fresh water to the water remaining the container 20 prior to refilling, which may adversely affect the taste of the brewed coffee. Depending on the recorded fluid levels and the fluid level when the user refills the container, the kitchen device 20 may prompt the user to empty the container 20 and dispose of all of the water in the container 20 prior to refilling.

In further embodiments where the kitchen device 30 comprises a water filter, a further magnet may be located in the filter of the water filter, thereby allowing the sensor 110 to detect whether the filter is being used. When no filter is detected by the sensor 110, the information can be recoded for future diagnostics or warranty, and/or an alert may be issued to the user to use the filter.

Various forms of the fluid level detection system described above may have one or more of the following advantages.

The fluid level detection system 10 is able to detect and determine the fluid level at any stage, irrespective of what proportion of the container 20 is filled with water. Moreover, the fluid level detection system 10 can determine the rate of change of the fluid level in the container 20, as well as detect if the container 20 is located in its appropriate location relative to the kitchen device 30 for use therewith and engaged with the kitchen device 30. The fluid level detection system 10 also allows the kitchen device 30 to alter its functions, options, processes, recipes etc. based on the detected fluid level, and to issue alerts or prompt the user to perform particular actions based on the detected fluid level.

Although specific embodiments of the invention are illustrated and described herein, it will be appreciated by those of ordinary skill in the art that a variety of alternative and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, etc. are used merely as labels, and are not intended to impose numerical requirements on or to establish a certain ranking of importance of their objects.

1. A fluid level detection system to determine a level of a fluid in a container engageable with a kitchen device, the fluid level detection system comprising:
a float comprising a magnet, the float being located in the container and movable relative to the container;
a sensor configured to detect a magnetic flux associated with the magnet, the sensor being located in the kitchen device; and
a controller communicatively coupled to the sensor, the sensor configured to provide to the controller a real-time feedback of the detected magnetic flux as the float moves relative to the container,
wherein the controller is configured to determine the level of the fluid in the container based on the detected magnetic flux.

2. The fluid level detection system of claim 1, wherein the controller is configured to determine that the container is not engaged with the kitchen device when the detected magnetic flux is lower than a predetermined value.

3. The fluid level detection system of claim 1, wherein the real-time feedback of the detected magnetic flux comprises a series of values of the detected magnetic flux, each value in the series of values of the detected magnetic flux being associated with a position of the float relative to the container that is different from positions of the float associated with remaining values in the series of values of the detected magnetic flux.

4. The fluid level detection system of claim 1, wherein the detected magnetic flux is a magnitude of the magnetic flux associated with the magnet.

5. The fluid level detection system of claim 1, wherein the float moves along a channel formed by a pair of guides.

6. The fluid level detection system of claim 1, wherein the float moves from a lower end of the container to an upper end of the container.

7. The fluid level detection system of claim 1, wherein the sensor is a magnetometer.

8. The fluid level detection system of claim 1, wherein the controller is configured to determine a rate of change of the level of the fluid based on a rate of change of the detected magnetic flux.

9. The fluid level detection system of claim 1, wherein each position of the float relative to the container is associated with a unique magnetic flux value.

10. The fluid level detection system of claim 1, wherein the controller is configured to determine a volume of the fluid in the container.

11. The fluid level detection system of claim 1, wherein the controller is configured to alert a user when the level of the fluid is low.

12. A method of detecting a fluid level of a fluid in a container engageable with a kitchen device, the method comprising:
detecting, by a sensor located in the kitchen device, a magnetic flux associated with a magnet in a float, the float being located in the container and movable relative to the container; and
determining, by a controller communicatively coupled to the sensor, the level of the fluid in the container based on the detected magnetic flux,
wherein the sensor is configured to provide to the controller a real-time feedback of the detected magnetic flux as the float moves relative to the container.

13. The method of claim 12, wherein determining the level of the fluid in the container includes:
determining, by the controller, that the container is not engaged with the kitchen device when the detected magnetic flux is lower than a predetermined value.

14. The method of claim 12, wherein the real-time feedback of the detected magnetic flux comprises a series of values of the detected magnetic flux, each value in the series of values of the detected magnetic flux being associated with a position of the float relative to the container that is different from positions of the float associated with remaining values in the series of values of the detected magnetic flux.

15. The method of claim 12, wherein determining the level of the fluid in the container includes:
determining, by the controller, a rate of change of the level of the fluid based on a rate of change of the detected magnetic flux.

16. The method of claim 12, wherein the method further comprises:
selectively disabling an option on a display of the kitchen device based on the level of the fluid,
receiving a user input to prepare a beverage, wherein the level of the fluid corresponds to a volume of the fluid that is sufficient to prepare the beverage.

17. The method of claim 12, wherein the method further comprises:
determining, by the controller, a time period since the level of the fluid was at a minimum level;
based on the determined time period, alerting a user to refill the container.

18. The method of claim 12, wherein the sensor is a magnetometer.

19. The method of claim 12, wherein determining the level of the fluid in the container includes:
determining, by the controller, a volume of the fluid in the container.

20. The method of claim 12, wherein the sensor provides the real-time feedback of the detected magnetic flux as the float moves from a lower end of the container to an upper end of the container.
